(19) United States
(12) Patent Application Publication
(10) Pub. No.: US 2006/0174302 A1
(43) Pub. Date: Aug. 3, 2006

(54) Automated remote monitoring system for construction sites

(76) Inventors: Bryan Mattern, Atlanta, GA (US); John Paulson, Atlanta, GA (US); Chandler McCormack, Atlanta, GA (US)

Correspondence Address: SUTHERLAND ASBILL & BRENNAN LLP, 999 PEACHTREE STREET, N.E., ATLANTA, GA, 30309, US

(21) Appl. No.: 11/048,496

(22) Filed: Feb. 1, 2005

(51) Int. Cl. H04N 7/173; H04N 7/18; H04N 9/47

(52) U.S. Cl. 725/105; 348/143

(57) ABSTRACT

The present invention relates generally to automated remote monitoring of construction projects. More particularly, the present invention relates to systems and methods for providing worldwide access to high-resolution images of construction projects, where the images are archived through the life of the project and can be accessed through secure connections to the Internet.

### TECHNICAL FIELD

The present invention relates generally to automated remote monitoring of construction projects. More particularly, the present invention relates to systems and methods for providing global access to high-resolution images of construction projects, where the images are archived through the life of the project and can be accessed through secure connections to the Internet.

### BACKGROUND OF THE INVENTION

Webcams have long been used to provide streaming video which may be accessed through the Internet. Individuals may access the Internet through the use of web browsers or other software and can view these streaming videos on the displays of their computers. However, the resolution of such videos is very low to facilitate the speed and bandwidth that most individuals have access to in using the Internet. In particular, many construction sites do not have access to high bandwidth connections to the Internet. The low resolution of these webcam images greatly limits their usage for applications where a larger, clearer picture is desired. For example, a security camera webcam feed may indicate an intruder, but may be unable to provide a picture clear enough to identify the individual, thus limiting its usefulness for an online security application. Likewise, a high resolution image is required for a user to see a functional level of detail necessary for construction site project management.

Construction project managers have long struggled with finding ways to effectively monitoring construction sites. Many project managers are overseeing multiple projects in multiple locations and cannot have their eye on every aspect of each project all the time. Equipment is commonly stolen from project sites, as unscrupulous individuals recognize the difficulty that a project manager would have in monitoring the site. Such monitoring capabilities are also extremely important for many other individuals involved in a construction project, for example, developers, consultants, investors, and other interested parties.

A further difficulty exists for project managers in tracking the progress of a particular project. For example, construction on a project is often delayed due to weather. However, there exists opportunities for workers to take days and time off when the weather truly does not necessitate it and the project manager cannot be on site every minute to monitor the weather condition. While generic weather data is available for general areas, this information is commonly not accurate enough to indicate the actual weather occurring at a particular location.

The use of traditional web cameras to monitor construction project sites for purposes of security and project monitoring has a number of problems that makes it impractical and relatively inept for those purposes. For example, many construction sites do not have dedicated high-bandwidth connections to the Internet available to facilitate streaming video at a resolution that would allow a project manager to monitor individuals effectively at the project site. Furthermore, the use of traditional web cameras does not allow the archiving of images for the life of the project so that a project manager would be able to confirm events based on a particular date and time in the past. Thus, a need exists for a system and method to allow high-resolution video images of project sites to be stored on a remote server, wherein a project manager can access them through a web enabled interface. A need further exists for a system for archiving said images in a format where they can be viewed through an interface allowing images to be pulled for specific past dates and times. There exists a further need for the images to be compiled in a format where they may be viewed in chronological order.

### SUMMARY OF THE INVENTION

The present invention meets the above-described needs by providing a system and method for the automated remote monitoring of a construction site. The system is made up of a remote camera component, the Internet, a remote server, a remote database, and a web interface. The remote camera may be set up in any desired location at which the project manager chooses to have the best view of a construction site. The system allows for the usage of multiple cameras depending upon the size of the construction site, so that the entire site may be monitored. In alternative embodiments of the present system, the cameras may be digital cameras and may communicate to the Internet via cellular telephone connections.

The camera component contains a timer and a controller to operate the camera as to create images at pre-determined times. The camera further contains a solid-state memory chip for temporary storage of camera settings and image files. The database allows for the archiving of image files of various sizes and formats, which may be organized by date and time that the images were created. The web interface allows for the viewing of the images in chronological order, and may be password protected.

These and other features, aspects and embodiments of the invention will be described in more detail below.

### BRIEF DESCRIPTION OF THE DRAWINGS

FIG. 1 is a block diagram illustrating an exemplary system in accordance with certain embodiments of the present invention.

FIG. 2, is a diagram illustrating an exemplary web interface in accordance with certain embodiments of the present invention.

FIG. 3, is a flow chart illustrating an exemplary method for remote camera operation in accordance with certain embodiments of the present invention.

FIG. 4, is a flow chart illustrating an exemplary method for storing images created by a camera at a remote construction site in accordance with certain embodiments of the present invention.

FIG. 5, is a flow chart illustrating an exemplary method for processing images at a server in accordance with certain embodiments of the present invention.

### DETAILED DESCRIPTION OF THE INVENTION

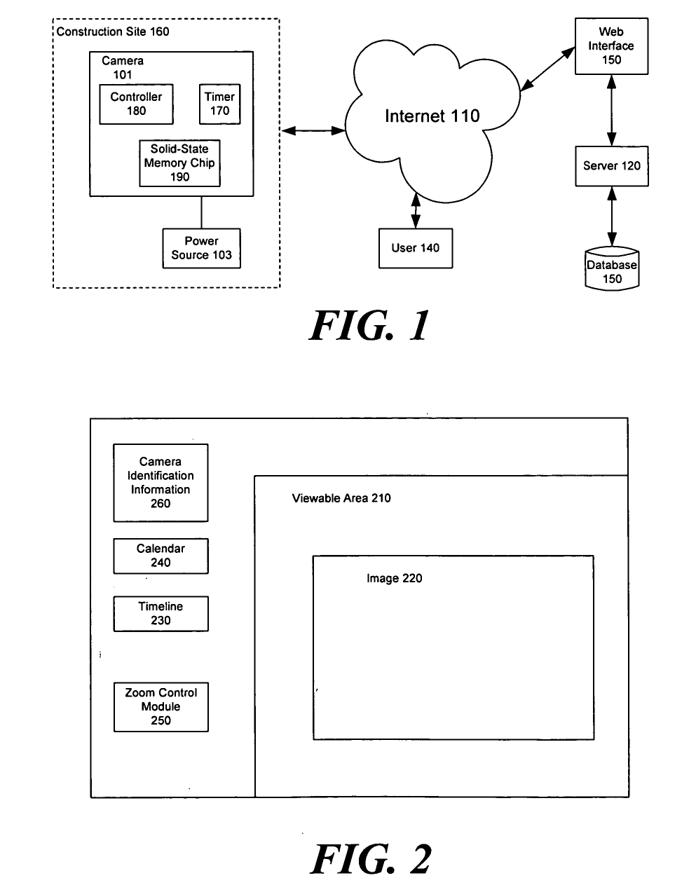

The system of the preferred embodiment may be described by reference to the figures. FIG. 1 is a block diagram illustrating an exemplary system in accordance with certain embodiments of the present invention. The digital camera 101 should be capable of taking high-resolution images, where high-resolution refers to images stored at a resolution greater than 640×480 pixels. In alternative embodiments of the invention, the camera 101 is powered through a solar panel system which generates the power necessary to operate the digital camera 101. In the preferred embodiment, the camera 101 operates through a wired power source 103.

The camera 101 is located at a construction site 160 which is located remotely from the central server 120. Each construction site 160, in the preferred embodiment, may have multiple cameras 101 which communicate to the central server 120 through a connection to the Internet 110. The number of cameras 101 located at each remote construction site 160 may range from one to any number of cameras 101. This allows a construction site 160 to be monitored from various angles and for the multiple cameras 101 to focus onto various areas located on the site 160. Each of the cameras 101 has the capability to transmit the stored images to the remote server 120. It should be understood that this invention may operate with any number of cameras 101 at each construction site 160.

In an alternative embodiment of the present invention, the cameras 101 transfer information to the remote server 120 via cellular telephone transmission, thus not requiring a directly wired connection to the Internet 110 for purposes of transmitting the images to the remote server 120. In the preferred embodiment of the present invention, the cameras 101 are connected to the Internet 110 through the use of traditional wired telephone lines. The system connects to the Internet 110 through dialing an Internet service provider, or employing other well-known methods for connecting to the Internet 110.

Located remote from the construction site, is a remote server 120 capable of receiving image files transmitted from the cameras 101 over the Internet 110. The server 120 is capable of being in communication with the remote database 130 as well as each of the cameras 101 located at the various remote construction sites 160. When the remote server 120 receives the image files, it subsequently moves the image files to the remote database 130 for long term storage. The process of movement from the server 120 to the remote database 130 is described in greater detail below. The remote database 130 stores the image files such that they are accessible by the server 120 at any time when a user 140 of the system wants to access the images through usage of the web interface 150.

Located remote from the construction site is a central database 130 with the storage capacity to hold image files from multiple cameras 101 creating images from multiple construction sites 160. In an alternative embodiment of the present invention, multiple databases may be used, each of which is connected to the central server 120. The images from each of the multiple databases may be accessed by the central server 120 and displayed on the web interface 150.

The preferred embodiment of the present invention includes a web interface 150 accessible via the Internet 110. A user 140 may use a personal computer running web browsing software to access the web interface 150. In an alternative embodiment of the present invention, access to the web interface 150 is controlled through a password-protected website. Thus, access is limited to prevent unscrupulous users from accessing images that may be proprietary to the operators of the construction site 160.

The web interface 150 includes a viewable area 210 on which the image is displayed. In the preferred embodiment of the present invention, the upper-most area of the web interface 150 and the left-most area of the interface 150 are employed to include controls to operate the features as described below.

The system contains a database component 130, a server component 120 and a web interface component 150. The database component 130 provides for long term storage of the image files, so that a user 140 of the system may access the entirety of stored images taken from a particular construction site 160. Furthermore, the database 130 allows a user 140 of the system to access individual images for various purposes, including marketing.

The database 130 may communicate with the server 120 as to transmit the image files to the server 120 when they are called upon for display. In an alternate embodiment of the invention, the image files are stored in subdirectories located within database 130, so that a subdirectory of images may be transferred to the server 120 for viewing on the web interface 150. For example, a sub-directory may contain all image files corresponding to a particular date for a particular camera 101 at a construction site 160. This may reduce the number of interactions between the database 130 and the server 120 thus increasing the overall speed of the system.

In an alternative embodiment of the present invention, multiple databases 130 may be used to accomplish the goals of securely backing up the image data, as well as providing extended storage capacity for a greater number of construction sites 160. Each of the multiple databases 130 may be connected to the central server 120, or alternative servers provided that the alternative servers are capable of transmitting the image information to the web interface 150. Likewise, in a separate alternative embodiment of the present invention, multiple databases 130 may be linked at the same location and operate using the same central server 120 for communication purposes. This embodiment would allow for greater storage capacity without the need for multiple remote locations for the databases 130 and the expense of additional servers 120 for communication.

The preferred embodiment of the present invention employs a web interface 150 which operates using the XML protocol. It should be noted that this is not an exclusive protocol to operate the interface under. A user 140 of the system can access the web interface 150 through any program capable of browsing Internet pages, for example Microsoft Internet Explorer. In an alternate embodiment of the present invention, access to the web interface 150 may be restricted by a password entry system.

In one embodiment of the present invention, the system initiates a middleware PHP layer. This middleware layer handles communications between the server 120 to the database 130 through usage of a SQL software interface. Likewise, the middleware layer may extract the directory structure as well as the image files to display on the web interface 150.

The web interface 150 as depicted in FIG. 2, initially displays a default image 220 for the date selected by the user 140. This default image 220 may be determined based on a particular time of day, or any other factor requested by the user 140. Once the default image 220 is displayed, the user 140 has the capability to move through subsequent images in chronological order. In the preferred embodiment of the invention, the web interface 150 includes information to alert the user 140 as to which camera 101 they are viewing images from. This is particularly useful for users 140 who are monitoring sites 160 that employ multiple cameras 101.

The web interface 150 may also include a graphical representation of a monthly calendar 240, wherein the user can select a particular date to view the default image 220 for that date and have subsequent access to all other images associated with the active camera 101 and selected date. The user 140 has the capability to change the active month viewed in the monthly calendar 240.

One advantage of displaying a high-resolution image is the ability to provide zooming capabilities for the user 140 to employ with any particular image that they view. The high resolution allows for a useful zoom, in that the user 140 can see intricate details that would not be available for them via traditional webcam technology. The web interface 150 contains a zoom control module 250 which allows the user 140 to adjust the zoom on the image 220. When the viewable area 210 is zoomed in so that less than the entire image 220 can be viewed on the interface 150, the preferred embodiment of the system allows the user to click and drag the image 220 as to control the area of the image 220 which is visible in the viewable area 210 of the web interface 150.

The web interface 150 may also contain a graphical representation of a timeline 230 where the user 140 may select a particular time on the timeline 230 to access the image 220 taken at that time. The timeline 230 may run from an early time in the selected date to a late time in the selected date. The timeline 230 may be organized so that each increment corresponds to each image 220 taken based on the pre-determined time interval on which camera 101 was set to store images. When a particular time is selected from the timeline 230, the corresponding image 220 for the selected time will be displayed in the viewable area 210 of the web interface 150.

In the preferred embodiment of the present invention, various pieces of identification information may also be displayed on the web interface 150. For example, the camera identification information 260 for the camera 101 from which the viewed image 220 originated may be displayed on the web interface 150. Likewise, the date and time of the current image 220 may also be displayed. Furthermore, information sufficient to identify the construction site 160 at which the camera 101 is located may be displayed. In an alternative embodiment of the current invention, the web interface 150 may be branded as to display prominently a customer's name for marketing purposes should they choose to allow outside parties to view their web interface 150.

The preferred embodiment of the present invention employs a timer device 170 which is physically located within the circuitry of the camera 101 located at the remote construction site 160. The timer 170 operates as to control the timing of when the camera 101 creates and stores images of the remote construction site 160. For example, in one embodiment of the invention, the timer 170 may operate as to effectuate the camera 101 to create images every fifteen minutes. This time period may be pre-determined and could be set to any time period based on the needs of the user 140 of the system.

Each camera 101 used in the preferred embodiment of the present invention contains a controller 180 which controls the connection between the camera 101 and its power source 103. The timer 170 operates in such a way to periodically cause the controller 180 to block the power source 103 from providing power to the camera 101. The timer 170 effectuates this process at a pre-determined time interval, for example, every sixty minutes. The timer 170 indicates to the controller 180 to reboot the system at each interval. At this point, the controller 180 is rebooted. This serves the purposes of fixing any problems caused by modem hangs, computer crashes, etc.

Each camera 101 in the preferred embodiment of the present invention also contains a solid-state memory chip 190, which operates similar to the RAM component of a personal computer. At the time of system start-up, as well as during each reboot of the controller 180, the camera 101 loads its operating system into the solid-state memory chip 190. Subsequently, the operating system starts a first script which controls the software module which handles the image creation and modification functions. Next, the operating system starts a second script which controls the software module which operates system diagnostic programs.

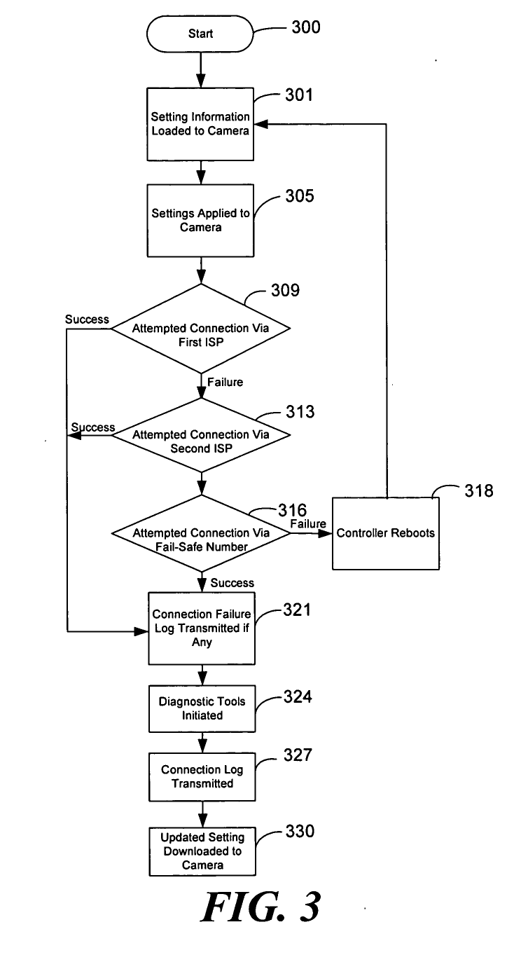

As referenced in FIG. 3, in the preferred embodiment of the present invention, the first script stores various information locally for the camera 101 to be used for the storage and the transmission of image files. For example, in one embodiment, at step 301, the script downloads the information needed for the camera 101 to access the Internet 110 through a direct connection or through the use of an Internet service provider. The script, at step 301, may load camera settings involving zoom, direction, resolution, and other similar settings. Likewise, at step 301 the script loads pre-determined time intervals appropriate for use with the timer component 170 of the camera 101.

The exemplary method proceeds to step 305 where the script applies the downloaded information to the camera 101. Subsequently, at step 309, the script attempts to connect the camera 101 to an Internet connection by using the loaded service provider information. This first attempt, in the case of a dial-up connection will dial the number and transmit login information to complete the connection to the Internet 110. However, many Internet service providers can become overloaded, and this initial connection attempt may fail. To overcome this problem, one embodiment of the present invention, upon failure at step 309, will proceed to step 313, where the system operates to attempt connection a second time through a different access telephone number or through a different Internet service provider. Similarly, if the second connection attempt fails at step 313, the system will proceed to step 316, where connection is next attempted through a pre-determined fail-safe toll free number loaded by the script at boot-up.

If no connection can be made after the last attempt at step 316, the system proceeds to step 318, where the controller 180 reboots and the system returns to step 301 and begins the connection procedure again. The system operates in this fashion until a successful connection is made. In the preferred embodiment of the system, the reasons for connection failure are stored on the solid-state memory chip 190. When a successful connection is made, the system proceeds to step 321, where a log of connection failures, if any, is transmitted to the remote server 120 for troubleshooting purposes.

In the preferred embodiment of the present invention, the system next proceeds to step 324, where the second script starts diagnostic tools to maintain proper operation of the camera system. This second script may be run at pre-determined intervals after the controller 170 boots up the system. For example, after the script begins, the system proceeds to step 327, where the camera transmits the connection log to the central server 120 for troubleshooting purposes. Next, the method proceeds to step 330, where the second script operates to download updated settings for the operation of the camera 101.

In one embodiment of the present invention, the settings downloaded in step 330 may include one or more of the following: camera zoom, white balance, resolution, sleep time in-between pictures, Internet service provider account information, information as to whether or not to accept the changes, file transfer protocol information, login information for the server, and time information. The file transfer protocol information may include the network address of the central server 120 so that the camera 101 knows where to address the stored image files queued for uploading to the central server 120.

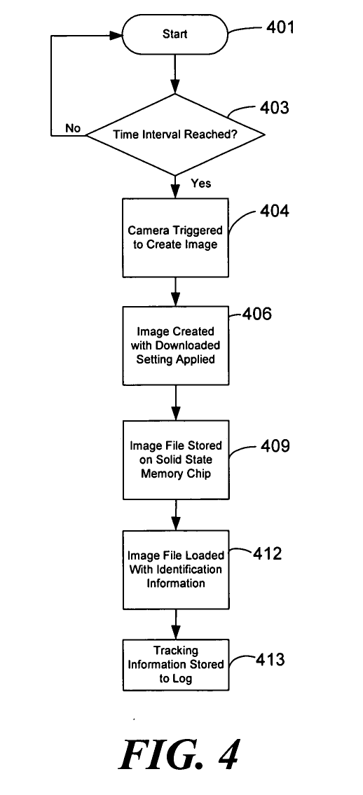

In the preferred embodiment of the present invention, the system operates as depicted in FIG. 4. At step 403, the method determines if a pre-determined time interval has been reached. If so, the method proceeds to step 404, where the camera 101 is triggered to create a new image of the construction site 160. If not, the method returns to the starting step 401. After an image is created by the camera 101, the method proceeds to step 406, where the camera 101 creates the image applying the downloaded camera settings. Next, at step 409, the image file is stored on the solid-state memory chip 190. In alternative embodiments, the camera 101 may incorporate a separate hard drive to store image information. The preferred embodiment uses a solid-state memory chip 190 to minimize the number of moving pieces stored in the camera 101 to increase the life of the camera 101. Likewise during a power outage, there will be no loss of stored data.

The exemplary method next proceeds to step 412, where the image file is labeled with identifying information which may include the time of image creation, as well as information which identifies the camera 101 which stored the image and the construction site 160 at which the image was created. The method then proceeds to step 415, where tracking information is stored in a log which can be transmitted to the central server 120. The information stored in this log may consist of time connected, memory usage, CPU usage, and connection speed during connections to the central server 120.

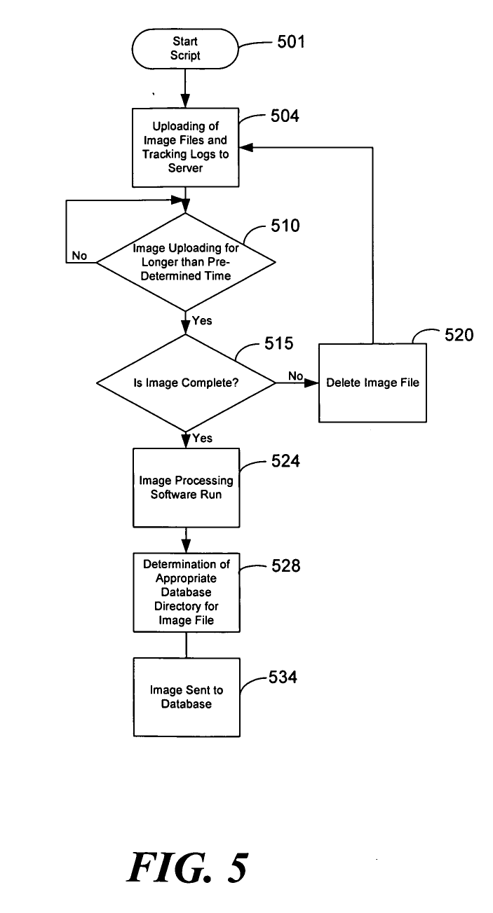

In the preferred embodiment of the present invention, the central server 120 operates as indicated in FIG. 5. At step 501, the server 120 begins scripts which control the receipt and transmission of information at the server 120 when a successful connection is made with the camera 101. The method proceeds to step 504, where the scripts cause the uploading of log information and image files from the remote camera 101. When the server receives an image file, the method proceeds to step 510, where the image file is prepared for transmission to the database 130.

The system operates to maintain a directory structure in the database 130 containing subdirectories for each date associated with each camera 101. Within the subdirectory, an indication is made of which image file serves as the default image file to display upon the user 140 selecting a particular date to view images via the web interface 150. These subdirectories may also be used for organization of the different file types made for each original image created. In the preferred embodiment of the present invention, the subdirectories are organized by date, containing all images associated with that date and the associated camera 101.

At step 510, for each image file that is uploaded from a remote camera 101, the image file is analyzed at the server 120 to determine if the image has been uploading for longer than a pre-determined amount of time. If the image has not been uploading for longer than the pre-determined amount of time, the method proceeds to step 515, where the server 120 scans the image to determine is the image is complete. If the image has been uploading for longer than the pre-determined amount of time and is not a complete image, the method proceeds to step 520, where the image is deleted and the server 120 records the event of the image deletion. After deletion of the image, the method returns to step 504.

Once an image is successfully uploaded, the method proceeds to step 524, where the server 120 runs image processing software to enhance the image. In one embodiment of the present invention, such enhancement may include the adjustment of auto-level and contrast. However, the limitations on image enhancement are based on the particular image processing software loaded on the server which may include any number of image processing options.

Next, at step 528, the server performs a comparison of the camera identification number associated with the image file with information stored in the database 130 to determine which remote construction site 160 the image file is associated with. Based on the identification of the appropriate construction site 160, the method proceeds to step 534, where the server 120 moves the image file to the appropriate directory in the directory structure for files in the database 130.

Subsequent to the determination of the appropriate location for storage of the file, the server 120 creates a number of image files from the initial image file. The central system may create a number of image files of various sizes (i.e., thumbnails), and file formats (i.e., .jpg, .swf, etc.). This allows a user 140 of the exemplary system to store lower resolution copies of the original image files for posting on various web sites separate from the web interface 150 integrated in the present system.

Similarly, the system operates to convert the uploaded time information associated with the image file to a human-readable format, which may be displayed on the web interface 150.

As may be seen from the foregoing, the present invention provides systems and methods for providing remote monitoring services for remote construction sites. It should be appreciated that the exemplary aspects and features of the present invention as described above are not intended to be interpreted as required or essential elements of the invention, unless explicitly stated as such. It should also be appreciated that the foregoing description of exemplary embodiments was provided by way of illustration only and that many other modifications, features, embodiments and operating environments are possible. Accordingly, the scope of the present invention should be limited only by the claims to follow.

I claim:

1. A system for remote monitoring of construction sites comprising:
a camera located at a remote construction site;
the camera being capable of taking high resolution image files at pre-determined time intervals;
a power source providing power to the camera;
a connection from the camera to the Internet via cellular means;
a remote server for moving image files to a database located remote from the construction site;
a web interface connected to the remote server and the database for displaying the image files;
the database storing the image files;
a timer connected to the camera, controlling the transmission of the image files from the camera to the server at set time intervals;
the timer blocking power at pre-determined time intervals causing the camera to reboot;
a controller for restricting access to the power source; and
a solid-state memory chip located in the camera for temporary storage of image files.

2. The system of claim 1, wherein the power source is a solar panel.

3. The system of claim 1, wherein the connection to the Internet is made through satellite means.

4. The system of claim 1, wherein access to the web interface is password protected.

5. The system of claim 1, further comprising one or more additional databases, remote from the first database wherein the image files are repetitively stored.

6. The system of claim 1, further comprising multiple cameras located at multiple remote construction sites;
wherein each camera communicates with the server through a connection to the Internet.

7. A method for operating a system for remote monitoring of construction sites comprising:
starting a first script which operates the image programs upon the rebooting of the system;
running the script at pre-determined time intervals;
storing information on a solid-state memory chip located on a camera concerning Internet connections, camera settings, and time intervals;
connecting to the Internet via a number of pre-determined Internet service providers;
if the system could not connect via the pre-determined Internet service providers, connecting to the Internet via a pre-determined fail-safe number;
if no connection can be made via the fail-safe number rebooting a controller;
tracking reasons for connection failures;
running a second script which handles system diagnostic programs;
creating an image file with the camera containing camera identification information;
transmitting the image file to the server;
transmitting the image file from the server to a database;
displaying the image file on a web interface.

8. The method of claim 7, wherein the camera settings includes one or more of camera zoom, white balance, resolution, sleep time in-between creating images, Internet service provider account information, information as to whether or not to accept the changes, file transfer protocol information, login information for the server, and time information.

9. A computer-readable medium having stored thereon computer-executable instructions for performing the method of claim 7.

10. The method of claim 7, further including the steps of executing the second script at pre-determined time intervals;
transmitting a connection log to the server.

11. The method of claim 10, wherein the connection log includes one or more of time connected to the server, memory usage, CPU usage, and connection speed.
